(19) United States
(12) Patent Application Publication
(10) Pub. No.: US 2018/0315185 A1
(43) Pub. Date: Nov. 1, 2018

(54) SYSTEM AND METHOD TO ANALYZE VARIOUS RETINAL LAYERS

(71) Applicant: Loma Linda University, Loma Linda, CA (US)

(72) Inventor: Shu-wei SUN, Loma Linda, CA (US)

(21) Appl. No.: 15/771,032

(22) PCT Filed: Oct. 26, 2016
(86) PCT No.: PCT/US2016/058925

§ 371 Date: Apr. 25, 2018

Related U.S. Application Data
(60) Provisional application No. 62/247,509, filed on Oct. 28, 2015.

(51) Int. Cl. G06T 7/00; G06T 7/60

(52) U.S. Cl. CPC G06T 7/0012; G06T 7/60; G06T 2207/20182; G06T 2207/30041; G06T 2207/20216; G06T 2207/10101

(57) ABSTRACT

The methods described herein include systems and methods that are configured to process images obtained using an OCT imaging system to analyze, parametrize and/or measure a thickness of one or more layers of the retina of various animals (e.g., mice, humans or other animals). The systems and methods can be used to analyze the various retinal layers of animals with normal/healthy retinas as well as the abnormal/damaged retinas.

### RELATED APPLICATION

This application claims the benefit under 35 U.S.C. § 119(e) of U.S. Provisional Patent Application No. 62/247,509, filed Oct. 28, 2015, titled “SYSTEM AND METHOD TO ANALYZE VARIOUS RETINAL LAYERS,” the entire contents of which are incorporated by reference herein and made a part of this specification.

### TECHNICAL FIELD

This disclosure generally relates to ophthalmic diagnostic systems and methods, and more particular to obtaining one or more parameters of various layers of the retina.

### DESCRIPTION OF THE RELATED TECHNOLOGY

Retinal pigment epithelium (RPE) and choroid are adjacent retinal layers acting in particular to transport metabolites and nutrients between photoreceptors and choriocapillaris, to produce growth factors for photoreceptors, to control the ionic equilibrium in the tissue, and to regulate the vitamin-A metabolism. Dysfunction of RPE-choroid complex (RC complex) can lead to various retinal diseases, including the age-related macular degeneration (AMD). In AMD, dysfunctions in RC complex are associated with layer deformation and the formations of confluent drusen. Early detection of the deformation in RC-complex can allow an early treatment of AMD as well as other retinal diseases.

### SUMMARY

Optical coherence tomography (OCT) is an imaging instrument that non-invasively collects three-dimensional imaging data of retina. Various imaging systems and methods, such as, for example, Spectral-Domain OCT (SD-OCT) can provide images with resolution in the range of 2-7 μm, depending on the chosen light source. Thus, imaging systems, such as, for example, SD-OCT can be used to obtain thickness of RPE-choroid complex (or RC-complex) which can be about 50 μm in mice and about 100 μm in humans. OCT, SD-OCT and other imaging systems can also be used to obtain parameters of other retinal layers including the RC-complex. SD-OCT and other OCT based imaging systems can also be used to detect morphological changes in the RC-complex.

One challenge in the clinical use of traditional OCT systems is that a physician has to review a large amount of image data to make a diagnosis. For example, a doctor may have to review more than 100 images obtained using an OCT system to make a diagnosis. In comparison, the doctor can make a diagnosis based on one color fundus image. However, a traditional color fundus image may suffer from reduced resolution and may not be capable of small changes or deformations in various retinal layers. Accordingly, a traditional fundus image may not be capable of diagnosing various ophthalmic diseased in early stages. Thus, systems and methods that facilitate quick and easy diagnosis of retinal conditions using the images obtained by OCT systems are advantageous.

The methods described herein utilize Gaussian curve fitting to automatically quantify the RPE-choroid complex layer thickness of retina of various animals (e.g., mice, humans or other animals). The systems and methods can be used to analyze the various retinal layers of animals with normal/healthy retinas as well as the abnormal/damaged retinas (e.g., retinas injured via an optic nerve crush (ONC)). Various embodiments of the methods described herein can advantageously: (a) allow results from analysis, parametrization and/or quantification of various retinal layers that are tolerant to shadows resulting from the underlying blood vessels or other structures that can suppress intensity of signals from the imaging system; (b) automatically produce a thickness map of the RC-complex layer from large volumes of data obtained from OCT systems; and (c) allow an automatic detection of drusen-like RPE-choroid deformations, which may have significant clinical impacts.

One innovative aspect of the subject matter disclosed herein can be implemented in a computer-implemented method to analyze RC-complex layer of a retina of an eye. The method comprises obtaining image data of the retina using an imaging system, the image data including signals representing intensity of light reflected from various layers of the retina. The imaging system can comprise an optical coherence tomograph (OCT) system. The method further comprises fitting a curve to at least a portion of the signals; and determining a parameter of the RC-complex layer from the curve. In various embodiments, the parameter can be a location of the RC-complex layer. In some embodiments, the parameter can be a thickness of the RC-complex layer. The curve can be fit to the portion of the signals having intensity greater than a threshold intensity.

Various embodiments of the method can further include averaging the image data to reduce noise. The image data can comprise one or more sets of first image data obtained at a plurality of depths of the retina. The image data can also comprise one or more sets of second image data obtained at various regions in an area of the retina. The method can include fitting a curve to the one or more sets of second image data to obtain a curvature of the retina. In various embodiments, a mathematical representation of the curve can comprise an exponential function. In some embodiments, a mathematical representation of the curve can comprise a quadratic function. In some embodiments, fitting a curve can include applying a nonlinear least square method to fit the portion of the signals with the curve. In various embodiments, the curve can be a Gaussian curve having a peak and a root means square (RMS) width. The location of the RC-complex layer can be determined from a position of the peak and the thickness of the RC-complex layer can be determined from the RMS width

Various embodiments of the method can include reconstructing a two-dimensional map of the RC-complex layer from the determined parameter. Various embodiments of the method can be configured to detect deformations in the two-dimensional map of the RC-complex layer to diagnose retinal damage.

Another innovative aspect of the subject matter disclosed herein can be implemented in a system for analyzing RC-complex layer of a retina of an eye. The system comprises an imaging system configured to obtain image data of the retina, the image data including signals representing intensity of light reflected from various layers of the retina; and processing electronics in electronic communication with the imaging system. The processing electronics are configured to fit a curve to at least a portion of the signals; and determine a parameter of the RC-complex layer from the curve. The imaging system can comprise an optical coherence tomograph (OCT) system. The imaging system can be configured to obtain image data by directing a beam of radiation at plurality of depths in a region of the retina. The imaging system can be configured to obtain image data by directing the beam of radiation at various regions in an area of the retina.

Another innovative aspect of the subject matter disclosed herein includes a non-transitory computer storage medium comprising instructions that when executed by an electronic processor cause the processor to perform a method. The method comprises receiving image data of a sample of retinal tissue obtained using an imaging system. The image data includes signals representing intensity of light reflected from RC-complex layer and one or more other layers of the sample. The method further comprises averaging the image data to generate averaged data with reduced noise; generating a fitted curve from at least a portion of the averaged data including signals with maximum intensity of light; and determining thickness of the RC-complex layer from the fitted curve.

In various embodiments, the imaging system can comprise an optical coherence tomograph (OCT) system. The image data can comprise one or more sets of first image data at plurality of depths in a first location of the sample. The image data can further comprises one or more sets of second image data at plurality of depths in a second location of the sample. The method can further comprise processing the one or more sets of first and second image data to account for curvature of the retinal tissue. The fitted curve can be mathematically represented by at least one of a Gaussian function, an exponential function or a quadratic function. The fitted curve can be mathematically represented by a Gaussian function and the thickness of the RC-complex layer can be determined from root mean square (RMS) width of the Gaussian function. For example, the thickness of the RC-complex layer can be equal to or be proportional to the root mean square (RMS) width of the Gaussian function. In various embodiments, the method can further comprise reconstructing a two-dimensional map of the RC-complex layer to aid in detection of deformations in the two-dimensional map of the RC-complex layer and/or to diagnose retinal damage.

### BRIEF DESCRIPTION OF THE DRAWINGS

FIG. 1A illustrates an example of an image of the retina obtained using an OCT system. FIG. 1B illustrates the intensity profile of light reflected from the various retinal layers. FIG. 1C illustrates a curve that is fit to the intensity profile of light reflected from the RC-complex layer.

FIG. 2 is a flow chart that illustrates an embodiment of a computer-implemented method to analyze and/or measure various parameters of a layer of the retina, such as, for example, the RC-complex layer.

FIG. 3A is an image obtained from the histology of the sample of mouse retina prepared as discussed above. The various retinal layers including the retina neural fiber layer (RNFL), inner plexiform layer (IPL), inner nuclear layer (INL), outer nuclear layer (ONL), IS/OS of photoreceptor layer (PRL), retinal pigment epithelium (RPE) and choroid can be observed in FIG. 3A. FIG. 3B shows an example of an image acquired by the OCT system (e.g., a b-scan) discussed above of the mouse retina.

FIG. 4A shows the RC-complex layer automatically detected by the computer-implemented method described above. FIG. 4B shows the detection RC-complex layer 401b that is detected manually. FIG. 4C shows a comparison between the thickness of the RC-complex layer measured automatically by the computer-implemented method described herein and the thickness of the RC-complex layer measured by manual delineation.

FIG. 5A shows the image of the fundus obtained with the OCT imaging system. FIG. 5B shows the two-dimensional thickness map of the RC-complex layer obtained using the computer-implemented method described herein. FIG. 5C shows the two-dimensional thickness map of the RC-complex layer obtained using manual delineation method.

FIG. 6A illustrates the fundus image obtained using the imaging system. FIG. 6B illustrates the two-dimensional thickness map of the RC-complex layer obtained using the computer-implemented method described herein. FIG. 6C illustrates the two-dimensional thickness map of the RC-complex layer obtained using manual delineation method. FIG. 6D illustrates an image including a plurality of a-scan images obtained using the OCT imaging system across the region of the retina indicated in FIG. 6B. FIG. 6E is an enlarged view of a portion of the image depicted in FIG. 6D. FIG. 6F is a histological image that is correlated with the OCT image shown in FIG. 6E.

FIG. 7A is a b-scan image that contributed to the two-dimensional thickness map of the RC-complex layer depicted in FIG. 5B. FIG. 7B shows the Gaussian curve fitting results of the row projections obtained by averaging the signal received from the OCT imaging system in the region of the RC-complex layer that corresponds to a region shown in FIG. 7A. FIG. 7C shows the Gaussian curve fitting results of the row projections obtained by averaging the signal received from the OCT imaging system in the region of the RC-complex layer that corresponds to another region shown in FIG. 7A.

### DETAILED DESCRIPTION

The systems, methods and devices of the disclosure each have several innovative aspects, no single one of which is solely responsible for the desirable attributes disclosed herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

High-resolution OCT imaging systems can generate tomographic images similar to tissue sections and permit visualization of retinal morphology. As discussed above, to analyze and/or parametrize various retinal layers to diagnose ophthalmic disorders, such as, for example, Age-related Macular Degeneration (AMD), a large number of OCT images are reviewed by a doctor. Conventional fundus images may not be able to detect small alterations in Retinal Pigment Epithelium (RPE) layers which may result in AMD. Automating portions of analysis, parametrization and/or quantification of the image data obtained using an OCT system, can be beneficial in an early diagnosis of AMD.

Several methods directed towards automatic methods of analyzing, parametrizing and/or measuring various retinal layers are generally based on edge and/or intensity gradient detections between the various retinal layers. Intensity variation, such as the shadows caused by the partial blockage of light, could disadvantageously affect the analysis, parametrization and/or quantification and thereby the accuracy of the diagnosis using these methods. Additionally, pathology-related retinal deformations may cause discontinuity of layers, which may make it more difficult to accurately analyze and/or parametrize the various retinal layers using these methods.

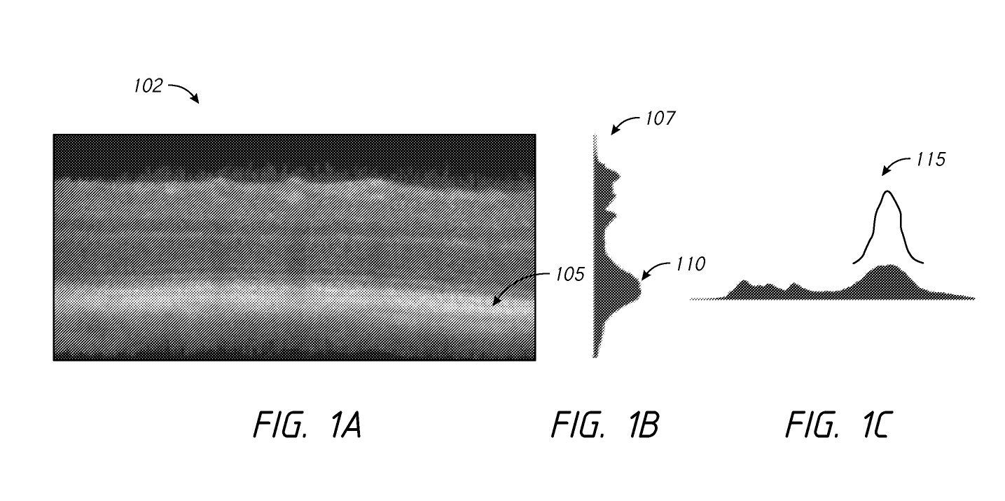

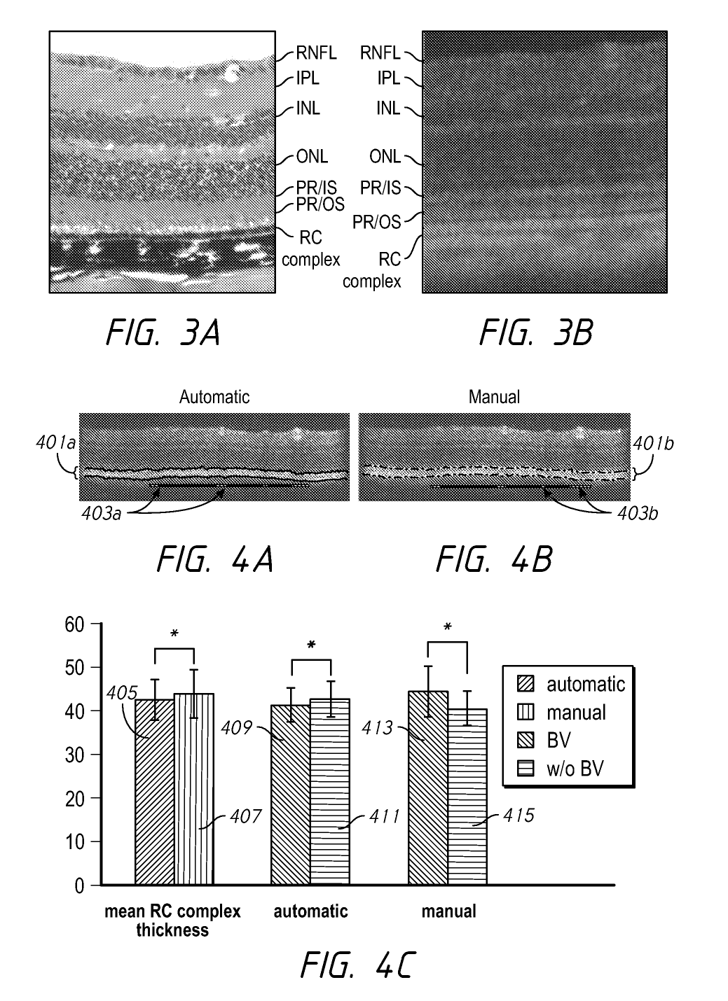

Various embodiments of systems and methods described herein are configured to analyze and/or measure various parameters of the RC-complex layer of the retina. FIG. 1A illustrates an example of an image 102 of the retina obtained using an OCT system. Various retinal layers (e.g., retinal nerve fiber layer (RNFL), inner plexiform layer (IPL), inner nuclear layer (INL), outer nuclear layer (ONL), photoreceptor layers (PRL) and the RC-complex layer) are discernible from the image 102. FIG. 3A and FIG. 3B described below also illustrate the various retinal layers. Among the various retinal layers, the RC-complex layer is unique due to the presence of melanin pigment granules. The presence of the melanin pigment granules is partially responsible for the contribution of the RC-complex layer to the high reflective signals obtained in the images obtained using an OCT system. A bright band 105 is observed in FIG. 1A which corresponds to the high intensity reflected signals from the RC-complex. Various embodiments of the methods disclosed herein take advantage of the high reflective signals from the RC-complex layer in one or more images obtained using an OCT system. FIG. 1B illustrates the intensity profile 107 of light reflected from the various retinal layers. As observed in FIG. 1B, the intensity of light reflected by the RC-complex layer is higher than the intensity of light reflected from other layers. Additionally, it is observed that the intensity profile 107 of light reflected from the RC-complex layer has a shape similar to a Gaussian curve. Accordingly various methods described herein are directed towards fitting a curve comprising an exponential and/or quadratic function (e.g., a Gaussian curve) to the signals from the RC-complex layer in one or more images obtained using an OCT system. FIG. 1C illustrates a curve 115 that is fit to the intensity profile of light reflected from the RC-complex layer.

One or more parameters of the fitted curve 115 can be correlated to the physical characteristics of the RC-complex layer, such as, for example, location of the RC-complex layer with respect to the border of the retina, thickness of the RC-complex layer, etc. Accordingly, the parameters of the fitted curve can be used to analyze, parametrize, measure and/or estimate the morphological features of RC-complex layer. For example, a thickness of the RC-complex can be obtained by using the method described herein. Accordingly, various embodiments of the methods described herein can advantageously facilitate quick and early diagnosis of AMD. Without any loss of generality, various embodiments of methods described herein include computer implemented algorithms that can automate measurements of RC-complex layer using Gaussian curve fitting methods. Embodiments of methods described herein can also be capable of detecting drusen-like RPE deformation, confirmed by histology.

Embodiment of a Computer-Implemented Method to Analyze and/or Measure RC-Complex Layer

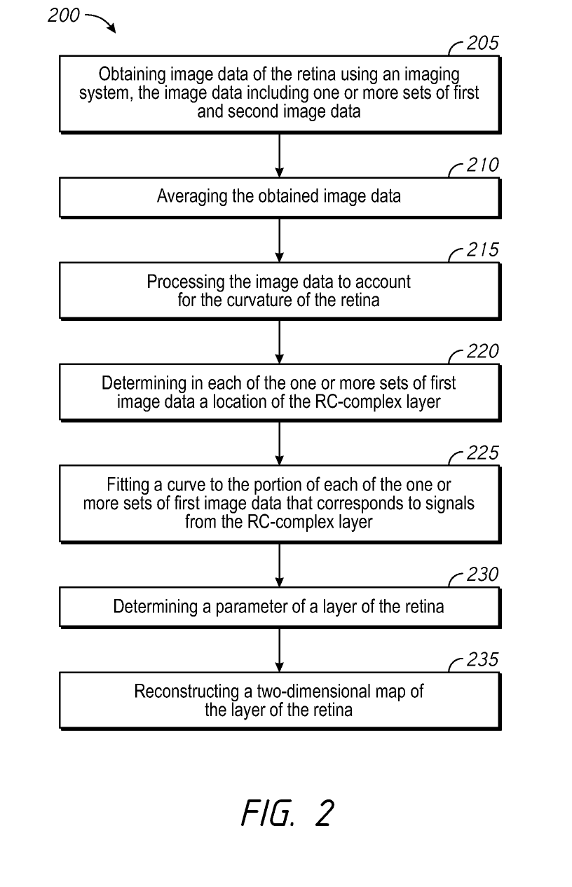

FIG. 2 is a flow chart that illustrates an embodiment of a computer-implemented method 200 to analyze and/or measure various parameters of a layer of the retina, such as, for example, the RC-complex layer. The method includes obtaining image data of the retina using an imaging system, as shown in block 205. In various embodiments of the method, the image data can be obtained using an OCT system, such as, for example a SD-OCT system. In some embodiments of the method, the image data can be obtained using an ophthalmic ultrasound system. In various embodiments of the method, the image data can include one or more sets of first image data. Each set of first image data can be obtained by directing a beam (e.g., a beam of light or an ultrasound beam) at a single position on the retina and collecting reflected and/or scattered beam from that portion of the retina at a plurality of depths, also referred to herein as a-scan image. In various embodiments of the method, the image data can include one or more sets of second image data. Each set of second image data can be obtained by scanning the beam across an area of the retina, also referred to herein as b-scan image. A volumetric image of the retina can be obtained by combining one or more sets of the first and the second image data. In various embodiments, each of the one or more sets of first and the second image data can include signals that represent intensity of light reflected from various retinal layers.

The image data (e.g., including one or more sets of first and/or second image data or each a-scan image and/or each b-scan image) can be mathematically averaged using to reduce noise, as shown in block 210. In various embodiments of the method, a computer-implemented algorithm can be used to average the image data. For example, in various embodiments, a multi-frame averaging function provided by a computer program (e.g., IVVC software) can be used to reduce noise. In some embodiments of the method, the first set of image data can be further processed using a one-dimensional (1-D) filter with an 11-pixel averaging in each a-scan to further remove noise. The image data (e.g., including one or more sets of first and/or second image data) can be further processed to account for the retinal curvature, as shown in block 215. The one or more sets of first and second image data can be processed using computer-implemented software and algorithms. For example, in some embodiments of the method image processing software, such as, for example, MATLAB® from MathWorks, Natick, Mass. can be used to perform various image processing functions described herein. For example, in some embodiments, the retinal curvature can be obtained by fitting a first curve (e.g., a quadratic curve) to the one or more set of second image data. The fitted first curve can have parameters that substantially mimic the curvature of retina in each b-scan image. The information provided by the fitted first curve can be used to straighten the retina. By straightening the retina (or by taking into account the curvature of the retina), the location of various retinal layers (e.g., the RC-complex layer) in each of the one or more sets of the first image data (or each a-scan image) can be predicted with greater precision and/or accuracy.

The method 200 further comprises determining in each of the one or more sets of first image data (or each a-scan image) a location of the RC-complex layer, as shown in block 220. Various methods of determining the location of the of the RC-complex layer in each of the one or more sets of first image data can be used. For example, when each of the one or more sets of first image data includes signals that represent intensity of light reflected from the various retinal layers, then a group of signals having intensity higher than a threshold intensity can be representative of signals reflected from the RC-complex layer. In various embodiments of the method, the threshold intensity can be a variable that is adjusted depending on various parameters of the imaging system. For example, the threshold intensity can depend on the signal-to-noise ratio (SNR) of the imaging system. Accordingly, the location of the RC-complex layer with respect to the boundary of the retina can be determined from the location of the group of signals with intensity greater than the threshold. Other mathematical or data analysis methods of correlating the location of the RC-complex layer to the intensity and/or amplitude of the signals in each of the one or more sets of first data can also be used to determine the location of the RC-complex layer. In various embodiments of the method, the relative location of RC-complex layer in each of the one or more sets of first image data (or each a-scan image) can be detected by using a combination of the strongest signal intensity and its distance relative to the border of retina.

The method 200 further comprises fitting a second curve to the portion of each of the one or more sets of first image data (or each a-scan image) that corresponds to signals from the RC-complex layer, as shown in block 225. The fitted second curve can comprise exponential functions, quadratic functions, polynomial functions or other mathematical functions. For example, the second curve can be a Gaussian curve G(x) mathematically represented by equation (1) below:

$$G ( x ) = {ae}^{- {( \frac{x - b}{c} )}^{2}} \qquad ( 1 )$$

In equation (1) above, the variable ‘a’ represents the peak value of the Gaussian curve G(x) which in various embodiments can correspond to the peak signal intensity. Referring to equation (1) above, the variable ‘b’ represents the location of the peak of the Gaussian curve G(x), which in various embodiments can correspond to the location of the RC-complex layer. With continued reference to equation (1), the variable ‘c’ represents the root mean square (RMS) width of the Gaussian curve G(x), which in various embodiments can correspond to the thickness of the RC-complex layer. In various embodiments of the method, a nonlinear least square method can be applied to fit the portion of each of the one or more sets of first image data (or each a-scan image) that corresponds to signals from the RC-complex layer with the Gaussian curve G(x). Accordingly, one or more parameters of the RC-complex layer (e.g., thickness and/or location of the RC-complex layer with respect to the boundary of the retina) can be determined from the fitted second curve, as shown in block 230.

The thickness of the RC-complex layer obtained from each of the one or more sets of first image data (or each a-scan image) using the methods described herein can be combined to reconstruct a two-dimensional RC-complex layer thickness map, as shown in block 235. It is appreciated that while the operations in the embodiment of the method 200 are depicted in FIG. 2 in a particular order, these operations need not be performed in the particular order shown. For example, the operation in block 220 can be performed after the operation in block 225 is performed. Accordingly, as noted above, the location of the RC-complex layer in each of the one or more sets of first image data can be determined from the curve fitted to the portion of each of the one or more of first image data that corresponds to signals from the RC-complex layer (e.g., region of the curve including signals with the highest intensities). As another example, the operation in block 220 can be performed simultaneously with the operation in block 230 after the operation in block 225 is performed. Accordingly, as noted above, the location of the RC-complex layer in each of the one or more sets of first image data and a parameter (e.g., thickness) of the RC-complex layer can be determined simultaneously from the curve fitted to the portion of each of the one or more of first image data that corresponds to signals from the RC-complex layer (e.g., region of the curve including signals with the highest intensities).

The computer-implemented method to analyze and/or measure the thickness of the RC-complex layer was used in an animal study described below and the obtained results were compared with the thickness of the RC-complex layer obtained using other methods to evaluate the efficacy of computer-implemented method to analyze and/or measure the thickness of the RC-complex layer.

### Materials and Methods

### Animals

All animal procedures were done in accordance with National Institutes of Health guidelines and Statement for the Use of Animals in Ophthalmic and Visual Research, and were approved by the Institutional Animal Care and Use Committee of the Loma Linda University.

### Optic Nerve Crush

Six 8-week old C57BL/6 female mice were anesthetized with a mixture of 20 mg/kg of xylazine and 10 mg/kg of Ketamine and an optic nerve crush procedure was performed on them. The optic nerve crush procedure included, creating a small incision in the conjunctiva, exposing the optic nerve behind the eye ball by using micro-forceps (Dumont #5/45 forceps, cat. #RS-5005; Roboz, MD). The optic nerve was then grasped approximately 1-3 mm from the globe with Dumont #N7 cross-action forceps (cat. #RS-5027; Roboz, MD) for 15 seconds. At the end of the procedure, a small amount of lubricant eye drops (Falcon Pharmaceuticals, Fort Worth, Tex.) was applied to the eye to protect it from drying. Another six age and gender-matched mice without surgery were used as controls.

### SD-OCT Imaging

The mouse pupils was dilated with 1% tropicamide (Bausch & Lomb Inc., CA) followed by the artificial tears. The mouse was seated in the animal imaging mount and rodent alignment stage. Images were obtained using an OCT imaging system, such as, for example OCT imaging system Envisu 2200-HR SD-OCT sold by Bioptigen, Durham, N.C. The images were acquired with a rectangular volume scan with area of 1.6 mm by 1.6 mm. The acquired images included 1000 a-scans/b-scan, with 3 frames/b-scan, and a total of 100 b-scans. The images were acquired using the InVivoVue Clinic (IVVC) application software configured for use with the OCT imaging system Envisu 2200-HR SD-OCT sold by Bioptigen, Durham, N.C. In some instances, the images were obtained five days after the optic nerve crush process.

### Histology

Mice were euthanized and perfused with Hartman's solution (Sigma, St. Louis, Mo.). The eyes of the euthanized mice were cut and immersed in Hartman's solution for 18 hours and then transferred to 4% formaldehyde solution for 2 weeks. The eyes of the euthanized mice were embedded in paraffin. Sagittal sections with 7 μm thickness were cut through the optic disc and stained with hematoxylin and eosin to obtain samples to study histology.

Results Obtained from the Computer-Implemented RC-Complex Analysis Method

FIG. 3A is an image obtained from the histology of the sample of mouse retina prepared as discussed above. The various retinal layers including the retina neural fiber layer (RNFL), inner plexiform layer (IPL), inner nuclear layer (INL), outer nuclear layer (ONL), IS/OS of photoreceptor layer (PRL), retinal pigment epithelium (RPE) and choroid can be observed in FIG. 3A. FIG. 3B shows an example of an image acquired by the OCT system (e.g., a b-scan) discussed above of the mouse retina. The image acquired by the OCT system shows a plurality of bands with varying brightness/intensity that result from light reflected from the various retinal layers. It is observed from FIG. 3B that the image acquired by the OCT is of good quality such that each cellular layer, including the retina neural fiber layer (RNFL), inner plexiform layer (IPL), inner nuclear layer (INL), outer nuclear layer (ONL), IS/OS of photoreceptor layer (PRL), retinal pigment epithelium (RPE) and choroid observed in the histology image shown in FIG. 3A can be matched to a corresponding intensity band of the OCT image shown in FIG. 3B. The computer-implemented automatic method to analyze, parametrize and/or measure the RC-complex layer described above was applied to the images acquired by the OCT system. The computer-implemented method was able to detect the RC-complex layer and also measure its thickness. FIG. 4A shows the RC-complex layer 401a automatically detected by the computer-implemented method described above and FIG. 4B shows the detection RC-complex layer 401b that is detected manually.

FIGS. 4A and 4B are identical images (e.g., b-scans) obtained by the OCT system with the difference being that the RC-complex layer 401a in FIG. 4A is detected automatically and its thickness is measured by the computer-implemented method described above while the RC-complex layer 401b in FIG. 4B is detected manually and its thickness is measured by manual delineation. FIG. 4C shows a comparison between the thickness of the RC-complex layer 401a measured automatically by the computer-implemented method described herein and represented by bar 405 and the thickness of the RC-complex layer 401b measured by manual delineation and represented by bar 407. The thickness of the RC-complex layer 401a as obtained by the computer-implemented method described herein is 42.89±4.64 μm. The thickness of the RC-complex layer 401b using manual delineation with 845 data points is 44.16±5.63 μm. FIG. 4C illustrates that the thickness of the RC-complex layer obtained by the automated computer-implemented method described herein is comparable to the thickness measured manually. The regions indicated by arrows 403a and 403b in the OCT images shown in FIGS. 4A and 4B indicate the location where the surface blood vessels cause shadows in OCT images. Bars 409 and 411 in FIG. 4C show the thickness of the RC-complex layer 401a measured using the computer-implemented methods described herein in locations having surface blood vessels that cause shadows and in locations that are devoid of surface blood vessels, respectively. Bars 413 and 415 in FIG. 4C show the thickness of the RC-complex layer 401b measured using the manual delineation method in locations having surface blood vessels that cause shadows and in locations that are devoid of surface blood vessels, respectively. The mean thickness in regions with surface blood vessel represented by bar 409 and without surface blood vessel represented by bar 411, obtained using the computer-implemented methods, was 41.61±3.88 μm and 42.85±4.09 μm respectively. The mean thickness in regions with surface blood vessels represented by bar 413 and without surface blood vessels represented by bar 415, obtained using manual delineation, was 44.72±6.03 μm and 40.92±3.93 μm, respectively. The difference in the thickness in regions including blood vessels and not including blood vessels when including the statistical margin of error is about 3% when thickness is measured using computer-implemented method described herein and about 9% when thickness is measured using manual delineation indicating that the thickness measurements made using the computer-implemented methods described herein are more tolerant to shadows caused by blood vessels than manual methods of measuring thickness.

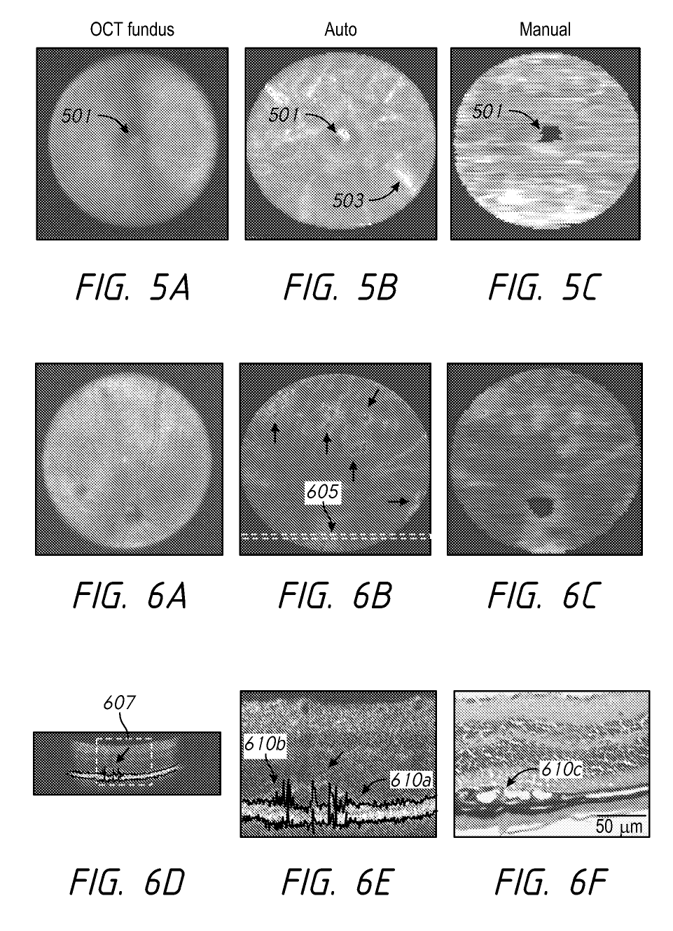

The computer-implemented method described herein can be used to process the entire volumetric image data obtained using the OCT imaging system to automatically generate an RC complex thickness map which is discussed below with reference to FIGS. 5A-5C below. FIG. 5A shows the image of the fundus obtained with the OCT imaging system. FIG. 5B shows the two-dimensional thickness map of the RC-complex layer obtained using the computer-implemented method described herein. FIG. 5C shows the two-dimensional thickness map of the RC-complex layer obtained using manual delineation method. The optic nerve head (ONH) 501 is visible in the OCT fundus image depicted in FIG. 5A and the RC-complex thickness maps depicted in FIGS. 5B and 5C. The thickness map of the RC-complex layer obtained using the computer-implemented method described herein shows additional structures 503 which may be a part of the choroid vessel networks. Compared to the thickness map of the RC-complex layer obtained using the computer-implemented method described herein, artificial horizontal traces are observed on the thickness map of the RC-complex layer obtained using manual delineation method.

### RC Complex Deformation

FIGS. 6A-6E depict images obtained using an OCT imaging system 5 days after the optic nerve crush procedure. FIG. 6A illustrates the fundus image obtained using the imaging system. FIG. 6B illustrates the two-dimensional thickness map of the RC-complex layer obtained using the computer-implemented method described herein. FIG. 6C illustrates the two-dimensional thickness map of the RC-complex layer obtained using manual delineation method. FIG. 6B illustrates deformations in RC-complex layer that are indicated by arrows in FIG. 6B. In contrast, the fundus image depicted in FIG. 6A does not show any deformations. FIG. 6D illustrates an image including a plurality of a-scan images obtained using the OCT imaging system across the region of the retina that corresponds to the region 605 indicated in FIG. 6B. FIG. 6E is an enlarged view of the portion 607 of the image depicted in FIG. 6D. FIG. 6F is a histological image that is correlated with the OCT image shown in FIG. 6E. The deformations observed in the two-dimensional thickness map of the RC-complex layer obtained using the computer-implemented method described herein can be confirmed from the thickening of the RC-complex layer in various regions (e.g., 610a and 610b) across the retina in the images depicted in FIGS. 6D and 6E. The histological image depicted in FIG. 6F also shows the deformation of the RC-complex layer in the region 610c. It is noted that the fundus image depicted in FIG. 6A did not indicate deformations of the RC-complex layer and thus is less effective in diagnosis than the OCT image. The deformations in the RC-complex layer observed in FIGS. 6B-6F can be associated with the formation of confluent drusen-like deformations which was verified by histological examinations.

### Clinical Applications

AMD is a devastating retinal damage affecting 30% of people over 75 years old. Traditional methods of diagnosing AMD rely on a color fundus photography (CFP) to detect the deformations in retinal pigment epithelium (RPE). However, as discussed above with reference to FIGS. 6A-6F, OCT images and/or two dimensional thickness map of the RC-complex layer obtained using computer-implemented methods described herein can provide greater image sensitivity and quality to detect the RPE deformation as compared to a fundus image. It is noted that the deformation can usually occur as a separation between the photoreceptor and RPE layers. Such a drusen-like layer separation can cause changes on RPE at the periphery of each drusen-like area, as to thicken the RC complex, which can be observed in OCT images including a plurality of a-scan images across an area of the retina and the RC-complex thickness maps reconstructed from the plurality of a-scan images. The drusen-like regions may appear as hollow shape on the RC-complex thickness maps.

It is noted that results of anatomical correlations between retina layer thickness derived from OCT imaging and histology may vary as a result of the tissue shrinkage after being processed for histological examination. Thus, comparison between the thickness measurements of various retinal layers, including the RC-complex layer, obtained from the computer-implemented method described herein and thickness of various retinal layers, including the RC-complex layer, obtained using manual delineation methods may be made to compare the accuracy and the precision with which the computer-implemented method described herein can measure the thickness of the various retinal layers.

### Choroid Feature Maps

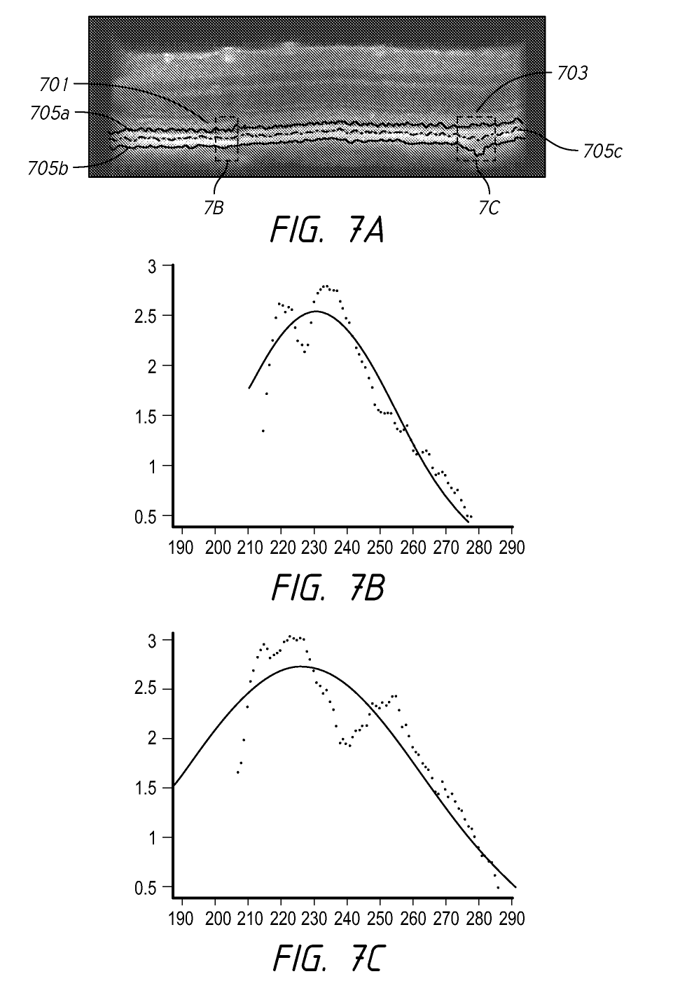

As discussed above with reference to FIG. 5B, various structures and/or textures 503 can be observed in the two-dimensional thickness map of the RC-complex layer obtained using the computer-implemented method described herein. These structures and/or features may be a result of thickening of the RC-complex layer which may be caused by the choroid layer. FIG. 7A is the 31^{st} b-scan image that contributed to the two-dimensional thickness map of the RC-complex layer depicted in FIG. 5B. In FIG. 7A, the region 701 of the RC-complex layer has normal thickness and the region 703 of the RC-complex layer has increased thickness. In FIG. 7A, reference numbers 705a and 705b denote the borders of RC-complex layer and the reference number 705c denotes the center of the RC-complex layer. FIG. 7B shows the Gaussian curve fitting results of the row projections obtained by averaging the signal received from the OCT imaging system in the region of the RC-complex layer that corresponds to region 701 shown in FIG. 7A. FIG. 7C shows the Gaussian curve fitting results of the row projections obtained by averaging the signal received from the OCT imaging system in the region of the RC-complex layer that corresponds to region 703 shown in FIG. 7A. Averaging the signal can better demonstrate the automated curve fitting method without interfering noises. The curve (solid line of FIG. 7C) that is fit to the distribution (or row projections) shown in FIG. 7C has a larger standard deviation (or RMS width) than the standard deviation (or RMS width) of the curve (solid line of FIG. 7D) that is fit to the distribution (or row projections) shown in FIG. 7B resulting in the RC-complex layer in the region 701 to have a larger thickness than the RC-complex layer in the region 703. The mean thickness in the region 701 obtained from the fitted curve in FIG. 7B is 54.33 μm and the mean thickness in the region 703 obtained from the fitted curve in FIG. 7C is 80.71 μm. The mean thickness in the region 703 is larger than the mean thickness in region 701 because of the existence of an additional peak in the row projection depicted in FIG. 7C. This additional peak is generated from the choroid layer which is adjacent to RPE layer and includes melanin pigments and blood vessels. In images obtained by an OCT imaging system of the mouse retina, these two layers may often be represented by a single bright layer. Hence the fitting results might be affected by distributions of melanin and/or blood vessels within choroid layer.

### ONC-Induced Drusen and Implications for AMD

Conducting ONC procedure in mice retina can result in similar innate immune responses as those caused by drusen-like structures. Furthermore, the phenomenon of reported photocoagulation-induced drusen regression can imply the reversibility of drusen-like structures in RPE layer. The mouse animal model of drusen is usually seen in, for instance, transgenic genes (Tg) mice or light damage of AMD mouse animal models. These models take long times to generate drusens for observing. Thus, in order to improve the time consuming procedures of mouse drusen animal models, the acute animal model like mouse ONC may provide an efficient way for developing the technologies of detecting the change of RPE-choroid complex layer.

### Analyzing Layers of the Human Retina

The computer-implemented method of analyzing and/or measuring the RC-complex layer can be adapted to be applied to images obtained using the OCT system from different animals, such as, for example mouse or human. Since, the size and signal profile of human retina are different from mouse, when considering to apply the computer-implemented method of analyzing and/or measuring the RC-complex layer on human retina data; various parameters of the algorithm, including noise threshold, signal filter size, and boundary setting of curve fitting coefficients can be adjusted depending on the characteristics of input image data.

The accuracy of the measured thickness of the RC-complex layer can be improved by excluding the optic nerve head (ONH) region of the retina when analyzing the images obtained by the OCT imaging system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blue-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain embodiments of the disclosure have been described, these embodiments have been presented by way of example only, and are not intended to limit the scope of the disclosure. No single feature or group of features is necessary for or required to be included in any particular embodiment. Reference throughout this disclosure to “various implementations,” “one implementation,” “some implementations,” “some embodiments,” “an embodiment,” or the like, means that a particular feature, structure, step, process, or characteristic described in connection with the embodiment is included in at least one embodiment. Thus, appearances of the phrases “in some embodiments,” “in an embodiment,” or the like, throughout this disclosure are not necessarily all referring to the same embodiment and may refer to one or more of the same or different embodiments. Indeed, the novel methods and systems described herein may be embodied in a variety of other forms; furthermore, various omissions, additions, substitutions, equivalents, rearrangements, and changes in the form of the embodiments described herein may be made without departing from the spirit of the inventions described herein.

For purposes of summarizing aspects of the disclosure, certain objects and advantages of particular embodiments are described in this disclosure. It is to be understood that not necessarily all such objects or advantages may be achieved in accordance with any particular implementation. Thus, for example, those skilled in the art will recognize that implementations may be provided or carried out in a manner that achieves or optimizes one advantage or group of advantages as taught herein without necessarily achieving other objects or advantages as may be taught or suggested herein.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A non-transitory computer storage medium comprising:
instructions that when executed by an electronic processor cause the processor to perform a method comprising:
receiving image data of a sample of retinal tissue obtained using an imaging system, the image data including signals representing intensity of light reflected from RC-complex layer and one or more other layers of the sample;
averaging the image data to generate averaged data with reduced noise;
generating a fitted curve from at least a portion of the averaged data including signals with maximum intensity of light; and
determining thickness of the RC-complex layer from the fitted curve.

2. The non-transitory storage medium of claim 1, wherein the imaging system comprises an optical coherence tomograph (OCT) system.

3. The non-transitory storage medium of claim 1, wherein the image data comprises one or more sets of first image data at plurality of depths in a first location of the sample.

4. The non-transitory storage medium of claim 3, wherein the image data further comprises one or more sets of second image data at plurality of depths in a second location of the sample.

5. The non-transitory storage medium of claim 4, wherein the method further comprises processing the one or more sets of first and second image data to account for curvature of the sample.

6. The non-transitory storage medium of claim 1, wherein the fitted curve is mathematically represented by at least one of a Gaussian function, an exponential function or a quadratic function.

7. The non-transitory storage medium of claim 1, wherein the fitted curve is mathematically represented by a Gaussian function and wherein the thickness of the RC-complex layer is determined from root mean square (RMS) width of the Gaussian function.

8. The non-transitory storage medium of any of claims 1-7, wherein the method further comprises reconstructing a two-dimensional map of the RC-complex layer.

9. The non-transitory storage medium of claim 8, wherein the method further comprises detecting deformations in the two-dimensional map of the RC-complex layer to diagnose retinal damage.

10. A computer-implemented method to analyze RC-complex layer of a retina of an eye, the method comprising:
obtaining image data of the retina using an imaging system, the image data including signals representing intensity of light reflected from various layers of the retina;
fitting a curve to at least a portion of the signals; and
determining a parameter of the RC-complex layer from the curve.

11. The method of claim 10, further comprising averaging the image data to reduce noise.

12. The method of claim 10, wherein the curve is fit to the portion of the signals having intensity greater than a threshold intensity.

13. The method of claim 10, wherein the imaging system comprises an optical coherence tomograph (OCT) system.

14. The method of claim 10, wherein obtaining the image data comprises obtaining one or more sets of first image data at a plurality of depths of the retina.

15. The method of any of claims 14, wherein obtaining the image data further comprises obtaining one or more sets of second image data at various regions in an area of the retina.

16. The method of claim 15, further comprising fitting a curve to the one or more sets of second image data to obtain a curvature of the retina.

17. The method of claim 10, wherein a mathematical representation of the curve comprises an exponential function.

18. The method of claim 10, wherein a mathematical representation of the curve comprises a quadratic function.

19. The method of claim 10, wherein fitting a curve comprises applying a nonlinear least square method to fit the portion of the signals with the curve.

20. The method of claim 10, wherein the parameter is a location of the RC-complex layer.

21. The method of claim 20, wherein the curve comprises a Gaussian curve having a peak, and wherein the location of the RC-complex layer is determined from a position of the peak.

22. The method of claim 10, wherein the parameter is a thickness of the RC-complex layer.

23. The method of claim 22, wherein the curve comprises a Gaussian curve having a root means square (RMS) width, and wherein the thickness of the RC-complex layer is determined from the RMS width.

24. The method of any of claims 10-23, further comprises reconstructing a two-dimensional map of the RC-complex layer from the determined parameter.

25. The method of claim 24, further comprising detecting deformations in the two-dimensional map of the RC-complex layer to diagnose retinal damage.

26. A system for analyzing RC-complex layer of a retina of an eye, the system comprising:
an imaging system configured to obtain image data of the retina, the image data including signals representing intensity of light reflected from various layers of the retina; and
processing electronics in electronic communication with the imaging system, the processing electronics configured to:
fit a curve to at least a portion of the signals; and
determine a parameter of the RC-complex layer from the curve.

27. The system of claim 26, wherein the imaging system comprises an optical coherence tomograph (OCT) system.

28. The system of any of claims 26-27, wherein the imaging system is configured to obtain image data by directing a beam of radiation at plurality of depths in a region of the retina.

29. The system of claim 28, wherein the imaging system is configured to obtain image data by directing the beam of radiation at various regions in an area of the retina.
